(19) United States
(12) Patent Application Publication
(10) Pub. No.: US 2021/0334612 A1
(43) Pub. Date: Oct. 28, 2021

(54) GENERATING MODIFIED IMAGES FROM SEED IMAGES

(71) Applicant: HEWLETT-PACKARD DEVELOPMENT COMPANY, L.P., Spring, TX (US)

(72) Inventors: Amir Gaash, Ness Ziona (IL); Ori Levron, Ness Ziona (IL); Guy Franco, Ness Ziona (IL); Guy Bibi, Ness Ziona (IL); Chen Peretz, Ness Ziona (IL); Shai Rubin, Ness Ziona (IL)

(21) Appl. No.: 16/605,511

(22) PCT Filed: Jun. 5, 2018
(86) PCT No.: PCT/US2018/036076

§ 371 Date: Oct. 16, 2019

(51) Int. Cl. G06K 15/02

(52) U.S. Cl. CPC G06K 15/1842; G06K 2215/0017; G06K 2215/111; G06K 15/1807

(57) ABSTRACT

In an example, a method includes selecting a unique identifier corresponding to a set of rules. At least one modified image is generated from a seed image using a processor by determining and applying an image attribute modification to the seed image according to at least one rule in the set of rules of the unique identifier. The modified image is placed in a predefined position according to at least one rule in the set of rules of the unique identifier.

### BACKGROUND

In designing and printing graphics a plurality of different designs may be used, with each design being a modification and/or a collage of at least one seed image. In some examples the graphics may be applied to product packaging.

### BRIEF DESCRIPTION OF DRAWINGS

Examples will now be described, by way of non-limiting example, with reference to the accompanying drawings, in which:

FIG. 1 is a flowchart of an example method;

FIG. 2 is a flowchart of an example method;

FIG. 3 is a simplified schematic representation of an example output of an example method;

FIG. 4 is an example apparatus; and

FIG. 5 is an example of a machine readable medium in association with a processor.

### DETAILED DESCRIPTION

In some circumstances, it may be intended to provide multiple images that have a degree of consistency or commonality. For example, product packaging may be varied while retaining a generally consistent look and feel. One aspect of this consistent look and feel may be that multiple packaging could display the same images but in different, distinct, ways. Packaging may, in some cases, be intended to remain with the item when it is in use (e.g. beverages) or packaging may, in other cases, be discarded without affecting the use of the product (e.g. electronic devices). Packaging may be designed to attract a consumer's attention by displaying “eye-catching” images. These images may be unique and distinct to a particular brand. Variations in the packaging may be one way of enhancing the attraction to consumers, for example by displaying the brand images in distinct ways across a range of packaging. One example way of achieving such variation is to collage one, or multiple, seed images. In such examples, a range of packaging may display the same seed images (which may be intrinsic to a particular brand) in unique and distinct ways, providing consistency across the set of designs but with each design being different and eye-catching.

Herein, by “collage” it is meant an image comprising at least one seed image, which for example may be a modified seed image. In some examples, the seed image may be reconfigured and/or combined with other images, which may be based on the same seed image and/or at least one different seed image, to form the collage.

Packaging provides just one example however. In other examples, the attraction of print media such as magazines, posters, newspapers, and the like may be enhanced by including variations between instances thereof.

While 2D printing to a substrate of a collage is discussed in some examples below the principles set out herein may be applied to 3D printing, or additive manufacturing, where an object to be generated may be modified, for example in terms of appearance (e.g. surface decoration) and/or shape, based on the principles set out below.

In some examples set out below, a seed image is used to produce a modified image which may then be placed, for example to form a collage. In some examples, at least one seed image (e.g. a first and a second seed image) may be used to produce the collage. In such examples, a first number of a first seed image and a second number of a second seed image may, each, be modified and then placed to form a collage. The resulting collage will then contain the first number of the first seed images and the second number of the second seed images, with each image being a modified image, modified according to at least one image attribute modification. However, in one example, a user may wish to produce a number of collages, with each collage featuring a first number of a first seed image and a second number of a second seed image. In this example, the resulting number of collages will each contain the first number of first seed images and the second number of second seed images, with each image being a modified image modified according to the at least one image attribute modification, however each collage may feature the images modified in different ways and placed in different positions within the collage. The way in which each individual image is modified according to the at least one image attribute modification, and the way in which each modified image is placed in the collage, may be determined by a unique parameter corresponding to one of the number of collages.

By using common seed images, each collage will each have an element of consistency.

In the context of 3D printing, the seed image may comprise data representing the appearance or shape of an object to be generated. Any seed, or modified image, in the context of 3D printing may be described in terms of ‘voxels’, e.g. 3D pixels, which may be associated with properties and/or materials (e.g. print agents to product colours and the like, and/or build materials which are to be solidified to form an object), or in some other way.

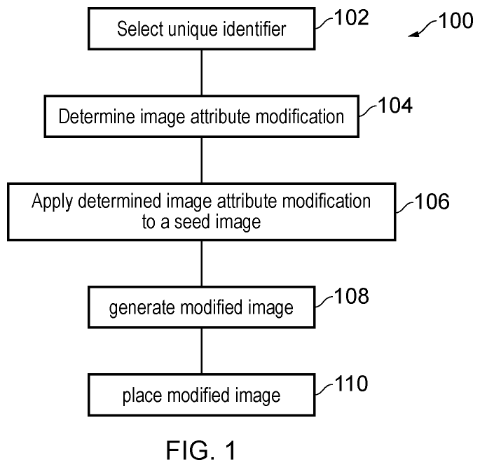

FIG. 1 is an example of a method 100, which may be a computer implemented method, and may be a method for generating a modified image from a seed image. The method 100 may be a method for generating a collage from a plurality of seed images. The method 100 may be a method for generating a plurality of collages from at least one seed image. The method 100 may be carried out using at least one processor.

The method comprises, in block 102, selecting a unique identifier corresponding to a set of rules. The set of rules comprises at least one of a rule relating to how to apply a particular image attribute modification to a seed image, thereby generating a modified image, and a rule relating to the placement of the modified image in a collage (or print) area.

Generating the modified image comprises, in block 104, determining an image attribute modification. For example, the image attribute modification may comprise any, or a combination, of cropping (i.e. selecting a portion of a seed image), a degree of magnification (e.g. zooming in on a portion of a seed image or zooming out on a portion of a seed image), a degree of rotation, reflection, distortion or skewing, flipping (e.g. vertically or horizontally) modification of colorization and/or transparency in the seed image, or the like.

In some examples the image attribute modification may be determined on-the-fly, for example, being a pseudo-random modification of a seed image. For example, a seed index may be input into a pseudo-random number generator, and an output may be used to indicate a set of modifications to be applied. In other example, an image attribute modification may be predetermined, for example being held in a memory or the like. For example, there may be a set of available predefined image modification attributes, which may, in some examples, depend on an image seed, and/or a set of predetermined rules or the like.

In some examples, a user may select an image attribute modification from a set of available image attribute modifications. In some examples, a user may select a plurality of image attribute modifications from a set of available image attribute modifications, each one of the selected image attribute modifications to be later applied to the seed image to generate the modified image. As will be set out below the image attribute modifications are applied according to a rule of the unique identifier.

In some examples, a plurality of seed images are to be modified and then placed to form a collage. In such an example, a user may select one image attribute modification, or a plurality of image attribute modifications, from a set of available image attribute modifications, and the selected image attribute modification(s) may applied to each seed image. The selected image attribute modification(s) may be different for each seed image.

For each image attribute modification there may be a range of possible values. For example, where the attribute modification is zooming, there may be a maximum zoom and a minimum zoom defining a zoom range therebetween, giving a maximum and minimum size of the resultant modified image. In this example applying the image attribute modification of zooming comprises zooming the image to a zoom value within the zoom range. Therefore, in this example, zooming the seed image may result in a modified image which is the seed image zoomed by a value within the zoom range. As will be explained below, the amount by which the seed image is zoomed is determined by at least one rule of a unique identifier, which may be pre-selected. In some examples the maximum zoom and/or the minimum zoom, and therefore at least part, or all of, the range, may be selectable. As another example, where the attribute modification is an amount of rotation there may be a maximum angle and a minimum angle of rotation defining a rotation range therebetween. In this example applying the image attribute modification of rotation to a seed image comprises rotating the seed image by a value within the rotation range. As will be explained below, the angle by which the seed image is rotated when applying this image attribute modification is determined by at least one rule of a unique identifier, which may be pre-selected.

Any parameters concerning the image attribute modification, e.g. a maximum and/or minimum valve thereof, may be selectable and/or adjustable. For example, a user may select the full range of possible values to be available, or may select a subset of the possible values from the full range.

Block 106 comprises applying the determined image attribute modification to a seed image. How the image attribute modification is applied to a seed image is determined by a set of rules of the selected unique identifier. For example, where the image attribute modification is zooming to a value within a zoom range, the unique identifier may comprise a rule that causes the seed image to be zoomed by a specific value within the zoom range. As another example, where the image attribute modification is rotation to an angle within a rotation range, the unique identifier may comprise a rule that causes the seed image to be rotated by a specific angle within the rotation range.

Block 108 comprises generating the modified image, which may comprise producing the seed image after the image attribute modification has been applied in block 106.

Block 110 comprises placing the modified image. Placing the modified image may comprise placing the modified image in a pre-selected area in which the collage is to be generated. In block 110 the modified image is placed according to at least one rule of the selected unique identifier. This may comprise placing the modified image at a selected position within a collage area, the selected position being determined by a rule in the unique identifier.

In one example the method 100 may be performed a second time on the same seed image. This will result in two modified images being generated which may then be placed in a single print area, i.e. in a single collage. In this example the selected unique identifier may result in the two images being modified in different ways by the same selected image attribute modifications. Specifically, at least one rule in the selected unique identifier may cause the same image attribute modification to be applied to the same seed image in a different way when the method 100 is performed subsequently. For example, where the image attribute modification is a scaling of between 50% and 100% the seed image's original size, a rule in the selected unique identifier may cause this attribute to be applied to the seed image such that the (first) modified seed image is at 60% of its original size, and such that the (second) modified seed image is at 75% of its original size. In this example the generated modified images are the seed image at 60% and 75% of its original size. The placement of the two modified images may be such that they overlap, and any degree of overlap may be determined by a rule in the selected unique identifier. Accordingly, this example results in a collage of the same seed image being modified and placed differently according to the same image attribute modification. In other words, the use of a unique identifier means that results are selectively reproducible or (as in the example) deliberately different from one another. Thus providing a unique identifier associated with a set of rules increases control over the resulting design.

In another example the method 100 may be performed a second time on a second seed image. This will result in two modified images being generated which may then be placed in a single print area, i.e. in a single collage. In this example, a different image attribute modification may be selected for each seed image. For example, the image attribute modification to be applied to the first seed image may be a scaling of between 100% and 150% of the first seed image's original size and the image attribute modification to be applied to the second seed image may be a rotation of an angle between 45 and 90 degrees. At least one rule in the set of rules of the selected unique identifier may determine how each attribute modification is applied to the first and second seed images. For example, one rule may cause the first seed image to be enlarged to 120% of its original size, and another rule may cause the second seed image to be rotated by 60 degrees. The generated images in this example will be the first seed image enlarged by the factor of 1.2 and the second seed image rotated by 60 degrees. The placement of the two modified images may be such that they overlap, with any degree of overlap being determined by a rule in the selected unique identifier. Accordingly, this example will result in a collage of two distinct seed images, each being modified and placed according to a rule of the unique identifier.

In another example the method 100 may be performed a second time for a second unique identifier, on the same set of seed images (either the same of different), with each modified seed image being placed in a different print area. For example, the method 100 may be performed a second time on the same seed image. In this example, the image attribute modification may be a rotation of an angle between 0 and 45 degrees. According to this example, when the method 100 is performed a first time, a rule of the first unique identifier may cause the seed image to be rotated by 15 degrees. This modified image may be placed in a first print area thereby producing a first collaged image. When the method 100 is performed a second time, a rule of the second unique identifier may cause the seed image to be rotated by 35 degrees. This modified image may be placed in a second print area thereby producing a second collaged image. Accordingly, this example will result in two different collages, each collage containing the same seed image modified in a different way according to the same image modification attribute.

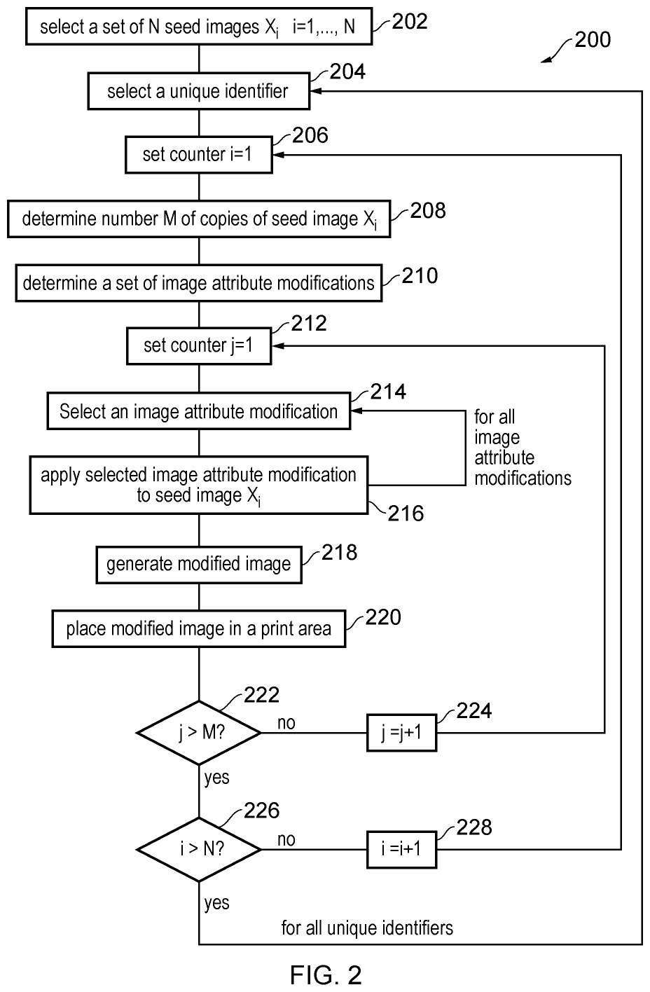

Examples of producing a number of collages from a set of seed images will now be discussed with reference to FIG. 2. FIG. 2 is an example of a method 200, which may be a computer implemented method.

Block 202 comprises selecting a set of seed images. As will be discussed below, each image in the set of seed images will be modified according a particular set of image attribute modifications and then placed to form a collage, and may appear in the collage a set number of times (this is achieved by setting a number of copies of each seed image). Block 202 comprises selecting a set of N seed images, with each individual seed image being denoted by xᵢ, i=1, . . . , N. The set of seed images may be determined by a user. In one example, the set of seed images may be determined from a larger set, e.g., on-the-fly by inputting a seed index into a random or pseudo-random number generator the output of which may correspond to a seed image, or set of seed images, to be modified.

Block 204 comprises selecting a unique identifier. The unique identifier corresponds to a set of rules which, as will be discussed below, will determine how a particular image attribute modification will be applied to a copy of each seed image, and how a copy of each seed image is to be placed in the collage. At least one unique identifier may be selected. Each unique identifier will correspond to a (distinct) way in which how a particular image attribute modification will be applied to a copy of each seed image and how a copy of each seed image is to be placed in the collage. Selecting multiple unique identifiers therefore results in multiple collages, with each collage featuring the modification and placement of copies of seed images according to rules of that unique identifier. As will be discussed below, selecting two unique identifiers (with the same set of seed images, number of copies, and image attribute modifications) will result in two distinct collages of the set of seed images, each copy of each seed image being placed, and modified by the same attribute modifications, as determined by a rule of each identifier.

Block 206 comprises setting a counter i=1. In this example, N seed images are to be collaged and the counter i will count from 1 to N. Setting the counter i=1 therefore corresponds to selecting the first seed image in the set of seed images.

Block 208 comprises determining a number of copies M of the seed image xᵢ. As above, N seed images are to be collaged and, in block 208, it is determined how many copies of each seed image are to appear in the collage. For example, two images may be collaged, and six copies of each image may be modified to be placed within the collage. By way of another example, three images may be collaged and one copy of the first, two copies of the second, and four copies of the third may be modified to be placed within the collage. The number of copies of each seed image in the set may be determined by a user. In one example, the a number of copies may be determined from a larger set, e.g., on-the-fly by inputting a seed index into a random or pseudo-random number generator the output of which may correspond to a number of copies of a seed image to be modified.

Block 210 comprises determining a set of image attribute modifications. The image attribute modifications determined in block 210 will be applied to each copy of the selected seed image. The set of image attribute modifications may therefore be the same for each individual seed image, even though (as below) they may be applied differently to each copy. Accordingly, any single seed may have the same set of image attribute modifications applied to it differently, the application of which is determined by the unique identifier selected in block 204. The set of images attribute modifications may comprise a single image attribute modificaiton, or a plurality of image attribute modificaitons. The set of image attribute modifications may be user-selectable, i.e. determined by a user, or may be determined on-the-fly, for example, being a random or a pseudo-random modification of a seed image. For example, a seed index may be input into a pseudo-random number generator, and an output may be used to indicate a set of image attribute modifications to be applied.

Block 212 comprises setting a counter j=1. In this example, M copies of a seed image xᵢ are to be modified and placed in the collage and the counter j will count from 1 to M. Setting the counter j=1 therefore corresponds to the resulting blocks being applied to the first (of M) copies of the seed image xᵢ.

Block 214 comprises selecting an image attribute modification from the set of image attribute modifications determined in block 210. Block 216 comprises applying the selected image attribute modification to the j^{th} copy of the selected seed image xᵢ. As indicated by the looping arrow, blocks 214 and 216 may be carried out for each image attribute modification. Once all image attribute modifications in the set have been applied to the copy of the appropriate seed image, the modified image is defined. Generating the modified image therefore comprises, at block 218, applying each image attribute modification in the set to the copy of the appropriate seed image.

Block 220 comprises placing the modified image in a print area. For i=1 and j=1 block 220 therefore represents placing the first copy of the first seed image (i.e. the first modified first image) in the collage. It will therefore be appreciated that, for i=1 and j=2, block 220 represents placing the second copy of the first seed image (i.e. the second modified first image) in the collage; and that, for i=2 and j=1, block 220 represents placing the first copy of the second seed image (i.e. the first modified second image) in the collage etc. It will therefore be appreciated that, in general, block 220 comprises placing the j^{th} modified i^{th} seed image in the collage.

In block 222, it is determined whether the counter j has reached M. If not, in block 224, the counter is incremented by 1 and the method returns back to block 212. This represents the method having not produced the number of copies of a given seed image and so the method returns back to block 212 to produce another modified image of the seed image. If the counter j has reached M then the method proceeds to block 226. This represents the method having produced the number of copies.

In block 226, it is determined whether the counter i has reached N. Having produced the number of copies of a given seed image the method may then advance to the next seed image in the set. If the counter i has not reached N then the method proceeds to block 228 in which the counter is incremented by 1 and the method returns back to block 206. This represents the method, having generated enough modified copies of one seed image in the set, proceeding to generate copies of the next seed image in the set. Once the counter i has been incremented by 1 then, at block 208 the number of copies of the next seed image (corresponding to i+1) is determined, etc. If the counter i has reached N then the method may terminate. However, as indicated by the looped arrow from block 226 to block 204, the method may repeat for each unique identifier.

Repeating the method 200 for a second unique identifier will therefore result in a second collage being produced. The second collage will contain the same number (N) of seed images, and the same number (M) of copies of each seed image. However, each copy of each seed image may be modified according to the same set of image attribute modifications, but these modifications may be applied differently according to the rules of the second unique identifier, and the resulting modified copies placed differently according to the second unique identifier.

The method 200 therefore allows distinct collages to be produced, each collage corresponding to a unique identifier whose set of rules dictate how particular image attribute modifications are to be applied and where a generated modified image is to be placed.

The rules of the unique identifier may therefore comprise at least one of: an image modification rule, determining how a particular image attribute modification is to be applied to a given seed image; and a placement rule, determine how a particular modified image is to be placed within the collage.

In one example, the method 200 may comprise defining a print area, which may be a subset of a larger area, the print area corresponding to the area in which the collage generated by the method 200 is to be placed. The print area may, for example, be a set area on a wider graphic, for example a specific area on product packaging. In such an example two versions of product packaging for one product may be the same, except for each containing a different collage of the same seed images within an area of that packaging.

In one example, at least one of the image attribute modification and a rule of the unique identifier may comprise generating a 3D appearance to the modified image. This may comprise applying a distortion or depth setting to the seed or modified image to give a 3D appearance to the image. At least one of the image attribute modification and a rule of the unique identifier may comprise a perspective modification, which may comprise a scaling to give the right impression of the height, width, and depth for a given image depending on the object that image depicts, and also the position of the modified image relative to other modified images in the collage. At least one of the image attribute modification and a rule of the unique identifier may comprise an overlap setting, which may determine the distance between generated modified images in the collage.

The unique identifier may comprise a rule relating to the placement of a modified image such that the modified image does not overlap with the borders defining a print area, which would thereby result in the image being inadvertently “cut” or cropped. Such a rule may therefore be regarded as a rule preventing placement of a modified image such that it overlaps with a boundary of a print area. The unique identifier may comprise a rule resulting in the selection of a subset of seed images from the set of seed images. For example, the method 200 may comprise selecting a subset of N′ (<N) seed images from the set of N seed images. The blocks of the method 200 may therefore be performed on that subset.

The method 200 may comprise outputting on the collage the unique identifier, or a graphic or alphanumeric symbol corresponding to the unique identifier. A second user may therefore know which unique identifier to select to reproduce the collage based on the collage itself.

The method 200 may therefore enable a second user to reproduce a collage, given at least the unique identifier. For example, a second user having viewed a set of collages may wish to order, or print, one of the collages. In such an example the user may input the unique identifier and a set of parameters, for example inputting these into an ordering system (for example by way of an online order form). The combination of the parameters and unique identifier may enable a user to reproduce a specific collage. For examples the set of parameters may include at least one of: a set of seed images, a number of copies of each seed image in the set, and a set of image attribute modifications to be applied to each copy of each seed image. The unique identifier may, as described with reference to the example of FIG. 2, determine how each parameter is applied to the seed images. Therefore the user having inputted the parameters and the unique identifier is able to reproduce the collage that uniquely corresponds to those parameters and the unique identifier. A one-to-one relationship may therefore exist between individual collages and the combination of: a unique identifier and parameters.

In order for a user to know which unique identifier corresponds to which collage, in examples where the method 200 comprises printing the resulting collage, e.g. on packaging, the method 200 may comprise printing the unique identifier. The final printed collage may therefore comprise/display the unique identifier, for example printed on the packaging with or over the collage. For example, the unique identifier may be printed on the final product as part of the collage. In one example, the unique identifier may be printed on the final product near the collage, for example adjacent to the collage. In one example, the unique identifier may be a plain number, human-readable font, or a combination thereof and printing the unique identifier may comprise printing the number or font. In one example, the unique identifier may be encoded as a QR symbol and printing the unique identifier may comprise printing the QR symbol. In this example, scanning the QR symbol may enable a user to retrieve the unique identifier. In another example, the unique identifier can be concatenated to a URL. In such an example, scanning a printed QR code may auto-redirect a user to a unique web page, which may allow the user to retrieve the unique identifier. The method 200 may comprise displaying a preview of the collage (for example in .jpg or .pdf format) so that the user may verify their choice prior to printing or ordering. A user may, with the unique identifier, therefore be able to reproduce a collage on a different background or different article (e.g. a different product such as a T-shirt or other packaging).

The method 200 may comprise selecting a background for the collage.

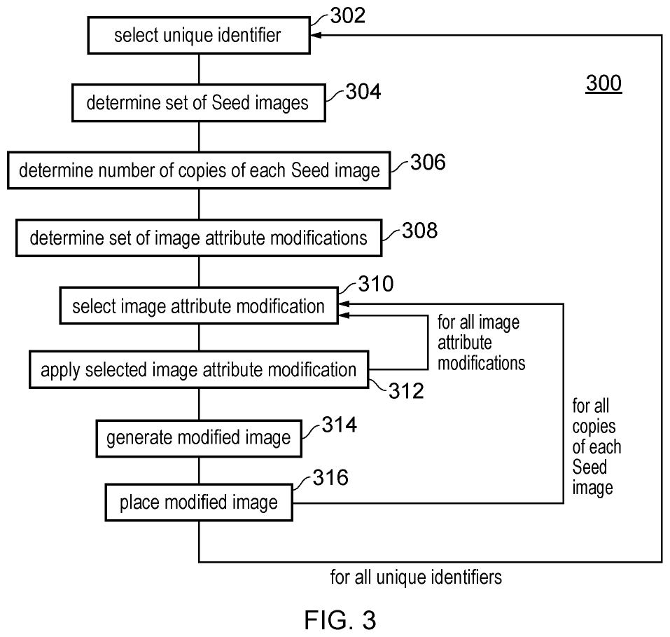

Further examples of producing a number of collages from a set of seed images will now be discussed with reference to FIG. 3. FIG. 3 is an example of a method 300, which may be a computer implemented method.

The method 300 comprises, in block 302 comprises selecting a unique identifier. In this example, the unique identifier corresponds to a set of seed images to be modified (e.g. a set of set N seed images). In one example, selecting a unique identifier corresponds to a selection of a subset of seed images from a wider set, e.g. on-the-fly by inputting a seed index into a pseudo-random number generator, the output of which may correspond to a particular set or subset of seed images.

Block 304 comprises determining a set of seed images. The available set may be determined by the unique identifier at block 302. In one example, block 304 may comprise determining a subset of seed images to be modified, from a wider set corresponding to the unique identifier selected at block 302.

The unique identifier, in this example, corresponds to a set of rules which determine at least one of: the set of seed images to be modified; the set of image attribute modifications by which the seed images are to be modified; how each image attribute modification in the set of image attribute modifications are to be applied to each seed image (each copy of each seed image); and how each modified seed image is to be placed in the collage. Each unique identifier may correspond to at least one of: a set of seed images; a set of image attribute modifications; a way of applying an image attribute modification; and how to place a modified seed image. Selecting multiple unique identifiers therefore results in multiple collages, each collage featuring a set of seed images modified and placed according to the rules of the unique identifier.

The set of seed images may therefore be determined by the unique identifier, and may be pseudo-randomly determined by the unique identifier. In block 306, a number of copies of each seed images may be determined. For example, a unique identifier may determine that two seed images are to be modified and one copy of the first, and three copies of the second are to appear in the collage.

Block 308 comprises determining a set of image attribute modifications. The set of image attribute modifications may be determined (e.g. pseudo-randomly), at block 308, based on the selected unique identifier. In one example, the unique identifier may determine a set of possible image attribute modifications to be applied and a user may select a subset to be applied in the resulting blocks of the method 300.

Block 310 comprises selecting an image attribute modification from the set of image attribute modifications in block 308. Block 312 comprises applying the selected image attribute modification to a copy of a seed image. As indicated by the looping arrow between blocks 312 and 310, applying an image attribute modification to a copy of a seed image is done for all image attribute modifications. The order in which the image attribute modifications are applied may be determined by the selected unique identifier.

Block 314 comprises generating the modified image, which therefore comprises applying each attribute modification to the copy of the seed image.

Block 316 comprises placing the modified image in a print area. The placement, in one example, the placement (i.e. the position in which each copy of each seed image is placed in the collage) may be determined by the unique identifier. In one example the placing may be random or pseudo-random, as determined by the unique identifier. For example a unique identifier may cause a seed index to be input into a pseudo-random number generator, the output of which may be used to determine the positioning of the or each copy of the or each seed image in the collage. In this way the positioning of the or each image may be randomised or pseudo-randomised, which, in one example, may be according to a selected unique identifier.

As indicated by the looping arrow between blocks 316 and 310, blocks 310-316 are performed for each copy of each seed image and the order in which this is done may be determined by the selected unique identifier. Therefore, the order in which the seed images are modified, and subsequently placed, may be determined by the unique identifier. In one example, the placement may be determined by the unique identifier. The use of a unique identifier therefore means that resulting collages are selectively reproducible and/or deliberately different from one another. This provides a unique identifier associated with a set of rules (which, as per the example of FIG. 3, may determine the seed images, the number of copies of seed images, the image attribute modifications, how these are applied to each copy, and how each copy is to be placed in a print area) which increases control over the resulting design.

As indicated by the looping arrow between blocks 316 and 302, the method 300 may be performed for a plurality of unique identifiers. Repeating the method 300 for a second unique identifier will result in a second collage being produced. This second collage may contain at least one of: different seed images, or the same seed images, a different number of copies of each seed image (where some seed images appear in both collages), their seed image being modified by different image attribute modifications, or modified differently by the same image attribute modifications, and placed differently.

A user may also perform part of method 300, for example a user may intervene to determine at least one of: a seed image to be modified, a copy of a seed image, and an image attribute modification.

The method 300 may enable a second user to reproduce a collage, given the unique identifier. As the unique identifier may correspond to at least one of: the set of seed images, number of copies, image attribute modifications, and placement instructions; a one-to-one relationship may exist between a unique identifier and a distinct collage. Therefore, a user, with the unique identifier is able to order the collage to which the unique identifier corresponds. The method 300 may comprise printing the collage that is the result of performing method 300. Printing the collage may comprise printing the unique identifier on the collage. For example, method 300 may produce a collage to be printed on product packaging. The unique identifier, in this example, may be printed on the collage and therefore on the product packaging. Another user, having seen the packaging and therefore the unique identifier, may then be able to reproduce the same collage. The unique identifier may comprise a URL, QR code or a string comprising a number and/or human-readable font. Scanning the QR code may reveal the unique identifier. In one example the unique identifier may be concatenated into a URL and scanning the QR symbol may redirect the user to a unique web page corresponding to the unique identifier.

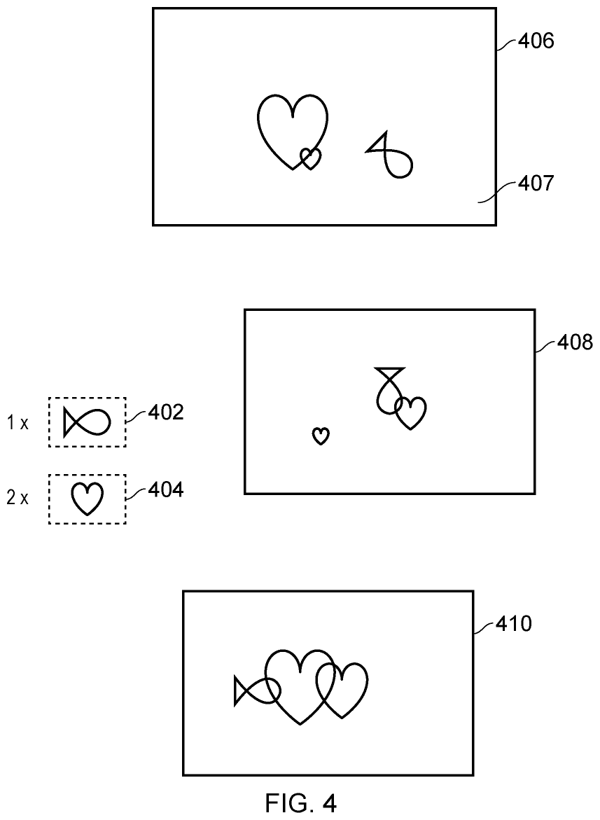

One example of the output of an example method, such as the example method 300 of FIG. 3, will now be described with reference to FIG. 4.

In the example of FIG. 4 two seed images 402 and 404 are to be collaged. The seed image 402 comprises a fish and the seed image 404 comprises a heart. In this example, the set of seed image therefore comprises seed images 402, 404. In this example, it is determined that one copy of seed image 302 and two copies of seed image 404 are to appear in the resulting collages. Three unique identifiers have been selected. Each unique identifier will correspond to a resulting collage 406, 408, 410.

Each unique identifier will cause a set of image modification parameters to be applied in different ways. Each collage will contain one copy of seed image 402 and two copies of seed image 404, modified according to the rules of the unique identifier corresponding to that particular collage.

In the example of FIG. 4 the image modification attributes for seed image 402 have been selected as: rotation between 45 and 90 degrees; and the image modification attributes for seed image 404 have been selected as: scale by a factor of between 0.5 and 2 (i.e. to a value between 50% and 200% of the seed image's original size).

As is shown in the example of FIG. 4, each unique identifier has caused these parameters to be applied to the respective seed images in different ways and each unique identifier has caused the generated modified images to be placed in different positions within the collages 406, 408, 410. In the depicted examples, the first unique identifier, corresponding to collage 406, has caused the image modification parameter of rotation between 45 and 90 degrees to be applied to seed image 402 such that it has been rotated by 45 degrees and placed approximately lower-centre-right of a print area 407. Similarly, the first unique identifier has caused the image attribution modification parameter of scale between 0.5 and 2 to be applied to the seed image 404 to produce a first copy in which the seed image has been scaled by a factor of 0.5 and placed in the lower-centre of print area 407 and to produce a second copy in which the seed image has been scaled by a factor of 2 and placed around the centre of print area 407. Similarly, for the second and third unique identifier's respectively corresponding to collages 408 and 410.

As the unique identifiers each comprise a set of rules determining how the image modification attributes are to be applied to a number of seed images a number of times, and how these modified images are to be placed in a collage, a second user having been given the unique identifier, the same set of seed images (and copies thereof), and the same set of image modification attributes, will be able to produce the same collage. For example, a user having been given seed images 402 and 404, the quantities of each seed image to be produced (in this example, one copy of seed image 402 and two copies of 404) and the set of image modification attributes (rotation between 45 and 90 degrees for seed image 402, scaling of a factor between 0.5 and 2 for seed image 404) will be able to produce a collage identical to collage 410 if they are given the unique identifier corresponding to that collage. The unique identifier may be alphanumeric, for example collages 406, 408 and 410 may correspond to the identifiers A1, A2, A3; or 1, 2, 3; or A, B, C, etc. In one example these identifiers may be printed on, or near, the collages to enable a second user to reproduce the collages. In another example the unique identifiers may be encoded as a QR symbol, and the QR symbol may be printed with the collages.

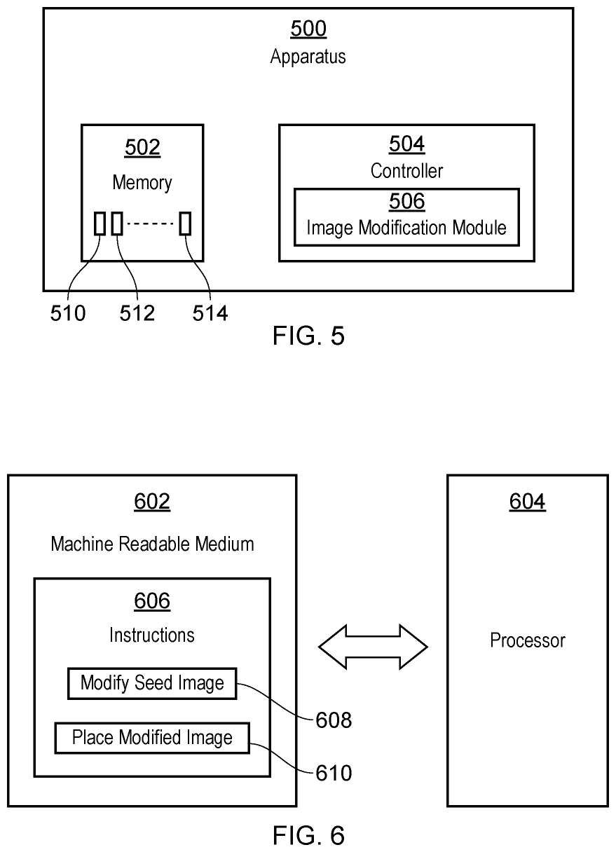

FIG. 5 is an example of an apparatus 500 comprising a memory 502 and a controller 504. The controller 504, which may comprise processing circuitry, comprises an image modification module 506. The memory 502 comprises a set of unique identifiers, denoted schematically by 510, 512, . . . , 514, wherein each unique identifier corresponds to a set of rules. In use of the apparatus 500, the image modification module 506 is to, for a seed image, apply an image attribute modification to the seed image to generate a modified image, wherein the image modification module is to apply the image attribute modification to the seed image according to at least one rule in a set of rules of a selected unique identifier to generate the modified image; and the controller 504 is to place the modified image in a predefined position according to at least one rule in a set of rules of a selected unique identifier.

The apparatus 500 of the example of FIG. 5 may perform any of the methods 100, 200 or 300 as set out in FIG. 1, 2 or 3, respectively.

FIG. 6 is an example of a tangible (and non-transitory) machine readable medium 602 in associated with a processor 604. The tangible machine readable medium 602 comprises instructions 606 which, when executed by the processor 604, cause the processor 604 to carry out a plurality of tasks. The instructions 606 comprise instructions 608 to cause the processor 604 to modify a seed image; and instructions 610 to cause the processor 604 to place the modified image. The instructions 608 are to cause the processor 604 to modify the seed image by applying an image attribute modification to the seed image according to at least one rule in a set of rules of a unique identifier to generate a modified image. The instructions 610 are to cause the processor 604 to place the modified image in a position according to at least one rule in a set of rules of a unique identifier.

The machine readable medium 602 of the example of FIG. 6 may comprise instruction to perform any, or any combination, of the blocks methods 100, 200 or 300 as set out in FIG. 1, 2 or 3, respectively, and/or to provide the image modification module 506 of FIG. 5.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
selecting a unique identifier corresponding to a set of rules;
generating, using a processor, at least one modified image from a seed image; and
placing, using a processor, the modified image; wherein generating the modified image comprises:
determining an image attribute modification; and
applying, using a processor, the determined image attribute modification to the seed image according to at least one rule in the set of rules of the unique identifier to generate the modified image; and wherein placing the modified image comprises:
placing the modified image in a predefined position according to at least one rule in the set of rules of the unique identifier.

2. A method as claimed in claim 1 wherein selecting a unique identifier comprises selecting a plurality of unique identifiers, each unique identifier corresponding to a different set of rules; and
wherein generating the at least one modified image from the seed image comprises:
generating at least one modified image from the seed image for each unique identifier in the selected set by, for each unique identifier:
applying the determined image attribute modification to the seed image according to at least one rule in the set of rules in the unique identifier.

3. A method as claimed in claim 2 wherein placing the modified image comprises, for each unique identifier, placing the at least one modified image in a print area.

4. A method as claimed in claim 1 wherein the seed image is a first seed image, the method further comprising:
generating, using a processor, at least one modified image from a second seed image; and
placing, using a processor, the modified second seed image; wherein generating the modified second seed image comprises:
applying, using a processor, the determined image attribute modification to the second seed image according to at least one rule in the set of rules of the unique identifier to generate the modified second seed image; and wherein placing the modified image comprises:
placing the modified second seed image in a predefined position according to at least one rule in the set of rules of the unique identifier.

5. A method as claimed in claim 4 further comprising defining a print area, and wherein placing the modified first and second seed image comprises placing the modified first and second images in a predefined position in the print area.

6. A method as claimed in claim 4 wherein the modified first and second seed images are placed to overlap one another, the method comprising determining an amount of overlap according to at least one rule in the set of rules of the unique identifier.

7. A method as claimed in claim 1 further comprising:
determining a number of copies of the seed image; and, for each copy:
generating, using a processor, at least one modified image from the seed image; and
placing, using a processor, the modified image; wherein generating the modified image comprises:
applying, using a processor, the determined image attribute modification to the seed image according to at least one rule in the set of rules of the unique identifier to generate the modified image; and wherein placing the modified image comprises:
placing the modified image in a predefined position according to at least one rule in the set of rules of the unique identifier.

8. A method as claimed in claim 7 further comprising defining a print area, and wherein each modified image is placed in a predefined position in the print area.

9. A method as claimed in claim 7 wherein the or each copy is placed in a print area to overlap one another, the method comprising determining an amount of overlap according to at last one rule in the set of rules of the unique identifier.

10. A method as claimed in claim 1, wherein selecting a unique identifier comprises selecting a plurality of unique identifiers, each unique identifier corresponding to a different set of rules; the method further comprising:
selecting a set of seed images, wherein the seed image is a first seed image in the set; and
for each seed image in the set of seed images, determining a number of copies of the seed image; and, for each copy:
generating, using a processor, at least one modified image from the seed image; and
placing, using a processor, the modified image; wherein generating the modified image comprises:
applying, using a processor, the determined image attribute modification to the seed image according to at least one rule in the set of rules of the unique identifier to generate the modified image; and wherein placing the modified image comprises:
placing the modified image in a predefined position according to at least one rule in the set of rules of the unique identifier; wherein, for each unique identifier, the modified images are placed in a print area.

11. A method as claimed in claim 1 wherein applying the image attribute modification comprises applying at least one of the following modifications to the seed image: cropping, rotating, translating, distorting, scaling, colour shuffling, colorization, applying transparency effects, reflecting, color depth variations, brightness adjustment, contrast adjustment, gamma correction, histogram equalisation and manipulation, flipping, warping, filtering.

12. A method as claimed in claim 1 further comprising defining a print area, wherein placing the modified image in a predefined position comprises placing the modified image in a predefined position in the print area; the method further comprising:
printing the print area,
wherein printing the print area comprises printing the unique identifier.

13. Apparatus comprising:
a memory comprising a set of unique identifiers, each unique identifier corresponding to a set of rules; and
a controller comprising:
an image modification module to, for a seed image:
apply an image attribute modification to the seed image to generate a modified image; and wherein the controller is to place the modified image;
wherein the image modification module is to apply the image attribute modification to the seed image according to at least one rule in a set of rules of a selected unique identifier to generate the modified image, and wherein the controller is to place the modified image in a predefined position according to at least one rule in a set of rules of a selected unique identifier.

14. Apparatus as claimed in claim 13 further comprising a printer, wherein the controller is to control the printer to print the modified image.

15. A non-transitory machine-readable storage medium, encoded with instructions executable by a processor, the machine-readable storage medium comprising instructions to cause the processor to:
modify a seed image by applying an image attribute modification to the seed image according to at least one rule in a set of rules of a unique identifier to generate a modified image; and
place the modified image in a position according to at least one rule in a set of rules of a unique identifier.
